(19) United States
(12) Patent Application Publication
(10) Pub. No.: US 2012/0082246 A1
(43) Pub. Date: Apr. 5, 2012

(54) SIGNAL TRANSMITTING DEVICE, SIGNAL RECEIVING DEVICE, SIGNAL TRANSCEIVER DEVICE AND SIGNAL TRANSMISSION METHOD

(75) Inventors: Chen-Tao Su, Zhonghe City (TW); Hong-Sheng Chen, Zhonghe City (TW)

(73) Assignee: What-Trend Technology Corp. Ltd., Zhonghe City (TW)

(21) Appl. No.: 12/894,251

(22) Filed: Sep. 30, 2010

(51) Int. Cl. H04L 27/00

(52) U.S. Cl. 375/259

(57) ABSTRACT

Signal transmitting device, signal receiving device, signal transceiver device and signal transmission method use a conductive case as a transmission line to transmit/receive a modulated control signal or a sensing signal. The signal transmitting device, the signal receiving device and the signal transceiver device adopt a capacitive coupling unit as a media to transmit/receive the modulated signal, which makes the conductive case as a carrier when coupling the modulated signal onto the conductive case. When the signal is carried on the conductive case, the modulated signal is able to be captured and well transmitted.

### BACKGROUND

1. Technical Field

The disclosure relates to signal transmission, and more particularly to signal transmitting device, signal receiving device, signal transceiver device and signal transmission method.

2. Related Art

Under the energy saving and carbon reduction environment, bicycle industry had regained its top industry position. For example, even under the Financial Tsunami in 2008, Giant Bicycle Inc. in Taiwan still gains growing revenue and profit rather than most other companies. Therefore, companies selling the accessories and the components of the bicycle also get a lot of profits under the booming healthy bicycle trend.

Accompany with the bicycle needs, the safety requirement becomes a major issue of the bicycles. For increasing the safety functions of the bicycles, the additional accessories had been provided first, such as Taiwan, R.O.C. patent M328,996, which discloses an alarming system of transportation vehicles. TWM328,996 adopts Zigbee technology for the control signal transmission for controlling the alarm functions operating on the bicycle.

Simplest alarming system is directly installing the transmission line for transmitting the controlling signal to the alarm device. For example, the alarm system of the bicycles or motorcycles is cheap on device cost and easy to install. However, this kind of additional alarm system is not a standard equipment and the installing fee as well as the additional components make a total cost higher than it should be. Otherwise, the additional transmission line consumes additional material more than wireless solution.

The wireless solutions are good design on free of transmission line but have their problem on the transmission signal loss. The problem makes the wireless solutions not as popular as transmission version.

Therefore, how to control the alarm device without the transmission line and get a convenient control environment like wireless solution is a good research approach.

### SUMMARY

Accordingly, the disclosure is directed to a signal transmission device and method using the same, which can provide a signal transmission technology without using a conventional transmission line.

The disclosure provides a signal transmission method, operating on a conductive case, includes the steps of: coupling a plurality of capacitive interfaces to a plurality of ends of the conductive case; modulating a transmission data as a modulated signal; transmitting the modulated signal to one end of the conductive case through the capacitive interface; capturing the modulated signal from other end of the conductive case; and demodulating the modulated signal as the transmission data for controlling a device coupled with the conductive case.

The disclosure further provides a signal transmitting device, operating on a conductive case, the device including: a frequency generation unit, for generating an operation frequency; a modulation unit, coupling to the frequency generation unit, for receiving an input data and using the operation frequency to modulate the input data as a modulated signal; and a capacitive coupling unit, coupling to the modulation unit and the conductive case, for providing the modulated signal to the conductive case.

The disclosure also provides a signal receiving device, operating on a conductive case, the device including: a capacitive coupling unit, coupling to the conductive case, for capturing a modulated signal carried on the conductive case; a frequency generation unit, for generating an operating frequency; and a demodulation unit, coupling to the capacitive coupling unit and the frequency generation unit, for receiving the modulated signal and using the operation frequency to demodulate the modulated signal as an output data.

The disclosure further provides a signal transceiver device, operating on a conductive case, the device including: a first frequency generation unit, for generating an first operation frequency; a modulation unit, coupling to the frequency generation unit, for receiving an input data and using the first operation frequency to modulate the input data as a first modulated signal; a first capacitive coupling unit, coupling to the modulation unit and the conductive case, for providing the first modulated signal to the conductive case and capturing a second modulated signal carried on the conductive case; and a demodulation unit, coupling to the first capacitive coupling unit, for receiving the second modulated signal and demodulating the second modulated signal as an output data.

Preferred embodiments and effects of the disclosure are illustrated below with reference to the accompanying drawings.

### BRIEF DESCRIPTION OF THE DRAWINGS

The disclosure will become more fully understood from the detailed description given herein below for illustration only, and thus not limitative of the disclosure, wherein:

FIG. 1 is a schematic view of a bicycle;

FIG. 2 is the flow chart of the signal transmission using the conductive case of the disclosure;

FIG. 3 is the first embodiment of the signal transmission using the conductive case of the disclosure;

FIG. 4A is the first embodiment of the signal transmission using the conductive case of the disclosure, the first end of the dual-transmission; and

FIG. 4B is the first embodiment of the signal transmission using the conductive case of the disclosure, the second end of the dual-transmission.

### DETAILED DESCRIPTION

The disclosure's feature is using a conductive case for signal transmitting/receiving to replace the transmission line of the related applications.

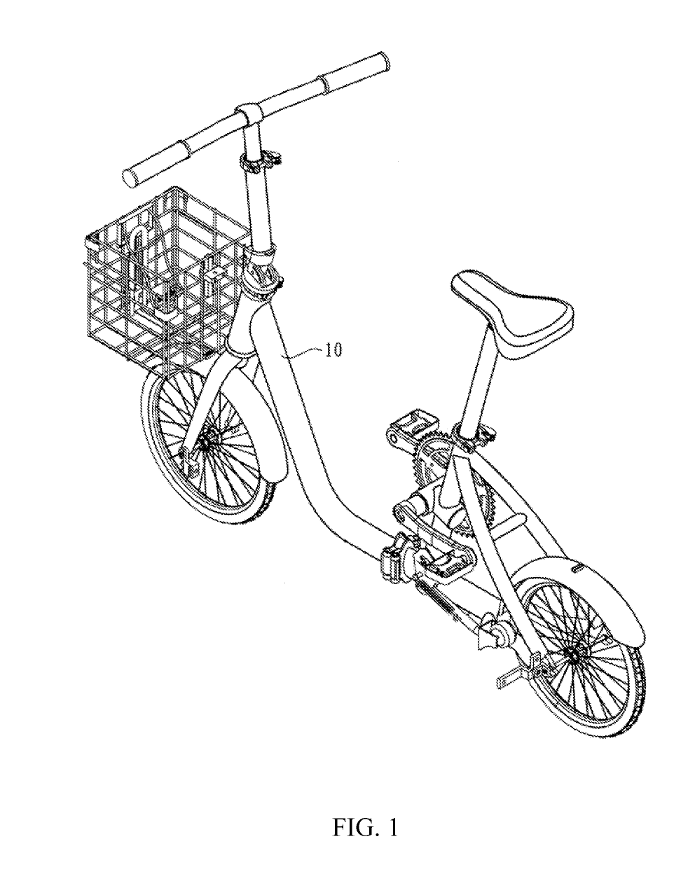

FIG. 1 is a schematic view of a bicycle. Basically, bicycle frame 10 uses metal or carbon fiber to fabricate. The frame 10 is not used for the signal transmission but for the sturdy and durable purposes. Therefore, the frame 10 design would not consider the transmission line feature, such as impedance matching.

However, even the conductive case used on bicycle, motorcycle, car, and other equipment having conductive case, the conductive material can be used as transmission line through the disclosure. The conductive case may be made by conductive metal, carbon fiber, and other conductive material. The equipment having conductive case may be LED light, street lamp, home appliance, etc.

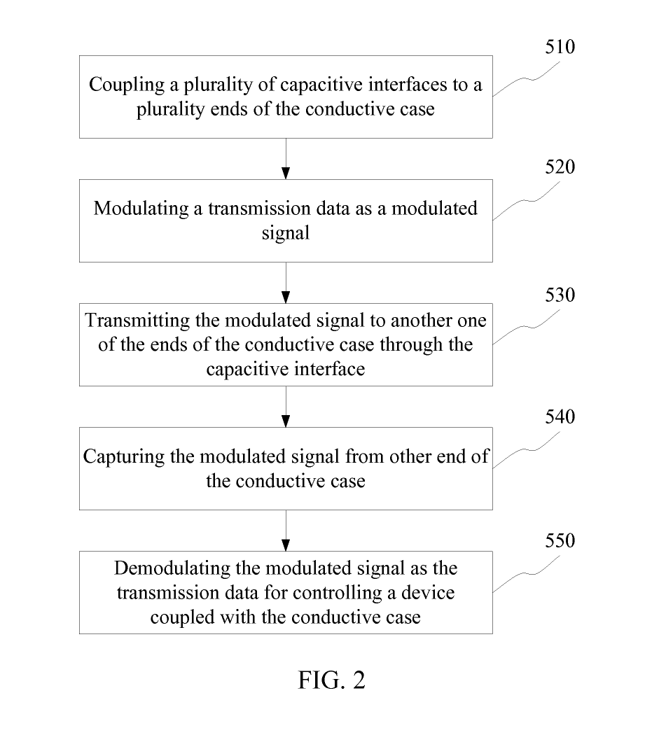

FIG. 2 is the flow chart of the signal transmission using the conductive case of the disclosure. The disclosure is featured on providing a capacitive interface, such as capacitance or a coil, for coupling to the conductive case. Under the coupling situation, the conductive case would gain its new feature which can provide an analog signal transmission. The featured flow is as following:

In step 510: coupling a plurality of capacitive interfaces to a plurality of ends of the conductive case.

In step 520: modulating a transmission data as a modulated signal. The modulation could be made by a modulated unit, which using an operation frequency to modulate the transmission data as the modulated signal.

In step 530: transmitting the modulated signal to another one of the ends of the conductive case through the capacitive interface.

In step 540: capturing the modulated signal from the other end of the conductive case.

In step 550: demodulating the modulated signal as the transmission data for controlling a device coupled with the conductive case.

The above method uses multiple capacitive interfaces for data transmission, which can perform at least one transmitting end to control at least one receiving end. For example, one control end for one controlled end, or one control end for multiple controlled ends, or multiple control ends for multiple controlled ends. The transmitted signal may carry control data or sensing data. For example, the transmit part is a temperature sensor, rotation sensor, or speed sensor and the receive part is a display. For example, the transmit part is a switch and the receive parts are the electric-magnetic break and direction lights.

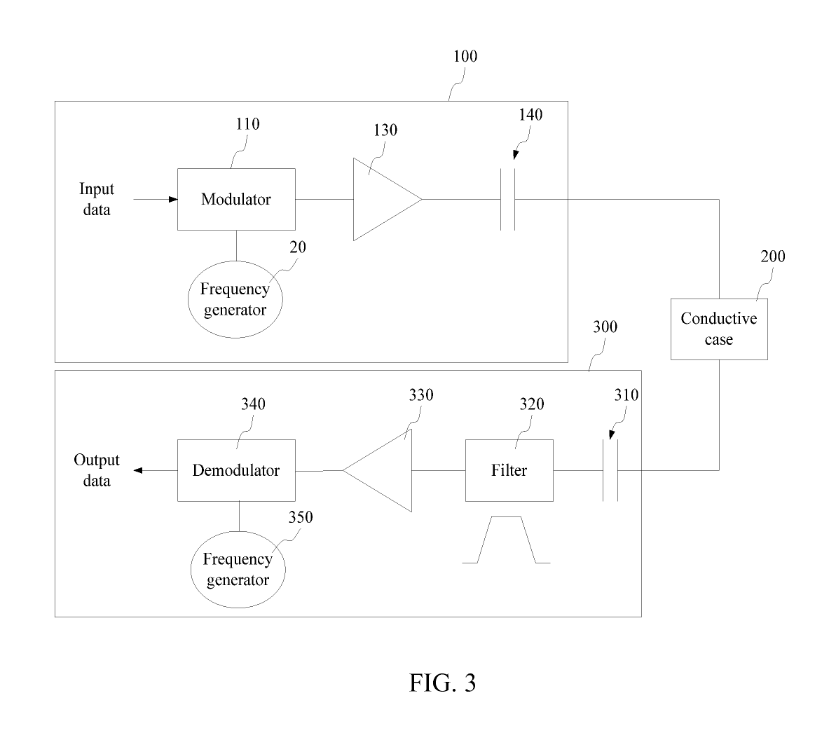

FIG. 3 is the first embodiment of the signal transmission using the conductive case of the disclosure. The first embodiment has two main parts: transmitting device 100 and receiving device 300. The transmitting device 100 and receiving device 300 are coupling to conductive case 200. The transmitting device 100 includes: modulator 110, frequency generator 120, amplifier 130, and capacitive unit 140. The receiving device 300 includes: capacitive unit 310, filter 320, amplifier 330, demodulator 340, and frequency generator 350.

The function and the detail of transmitting device 100 and the receiving device 300 will be describe under the signal flow descript below.

In the transmitting device 100, the frequency generator 120 generates an operation frequency and connects to the modulator 110. The modulator 110 receives the input data and uses the operation frequency to modulate the input data as modulated signal. The amplifier 130 connects to the modulator 110, amplifies the modulated signal, and sends to the capacitive unit 140. The capacitive unit 140 couples to the conductive case 200, and then transmits the amplified modulated signal to the conductive case 200.

The transmitting device 100 is located at one end of the conductive case 200, while the receiving device 300 is located at another one of the ends of the conductive case 200. Therefore, through the conductive case, the modulated signal can be transmitted from the transmitting device 100 to the receiving device 300.

In the receiving device 300, the modulated signal is carried on the conductive case 200. Through the capacitive unit 310 coupling to the conductive case 200 the capacitive unit 310 can capture the modulated signal. The filter 320 connects to the capacitive unit 310 and filters the noise generated on the conductive case 200. The amplifier 330 connects to the filter 320, amplifies the filtered modulated signal. The demodulator 340 connects to the frequency generator 350 and the amplifier 330. The demodulator 340 can demodulate the modulated signal as the original input data and output as an output data.

In the transmitting device 100, the frequency generator 120 can be a LC oscillator, Voltage controlled oscillator (VCO), or a crystal. Modulator 110 can use the below technique, such as: AM, FM, PM, or OOK, FSK, ASK, PSK, QAMMSK, CPM, PPM, TCM, OFDM, or FHSS, DSSS, etc. Capacitive unit 140 could be a single metal plate; the single metal plate combines with the conductive case 200 to formulate a capacitance. Another embodiment is the capacitive unit 140 can contain a single metal plate with an insulation film to formulate a capacitance with the conductive case 200. For example, the capacitive unit 140 can be installed onto the handlebar of a bicycle, and the capacitive unit 140 can be fixed on the handlebar at the same time.

In the receiving device 300, the capacitive unit 310 can be designed as the same structure as capacitive unit 140. In another embodiment, the capacitive unit 310 also can be a coil. The filter 320 can be a band pass filter to filtering out the default operation frequency of the modulated signal and get rid of the noise. The amplifier 300 can adopt Low noise amplifier (LNA), and the demodulator 340 is using the same technology as modulator 110.

Under the cooperation of the transmitting device 100 and the receiving device 300, the conductive case 200 is used as a transmission line. That is, the disclosure provides a transmission line free technology rather than the wireless technology. The disclosure then can provide a low BOM cost and installation cost technology.

The embodiment describes in FIG. 3 is one-way signal transmission schema. The disclosure also provides two way signal transmission such as full-duplex or half-duplex for at least two transceivers. The same schema also can be utilized to more complex system, such as, one transmitting device with at least two receivers, at least one transceiver device with at least one transmitting device and at least one receiving device, etc.

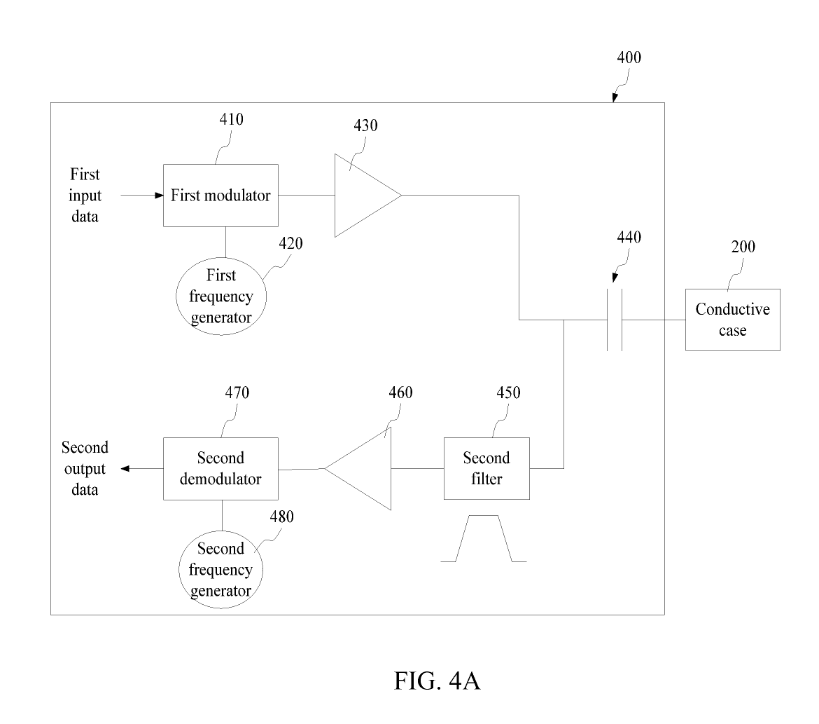

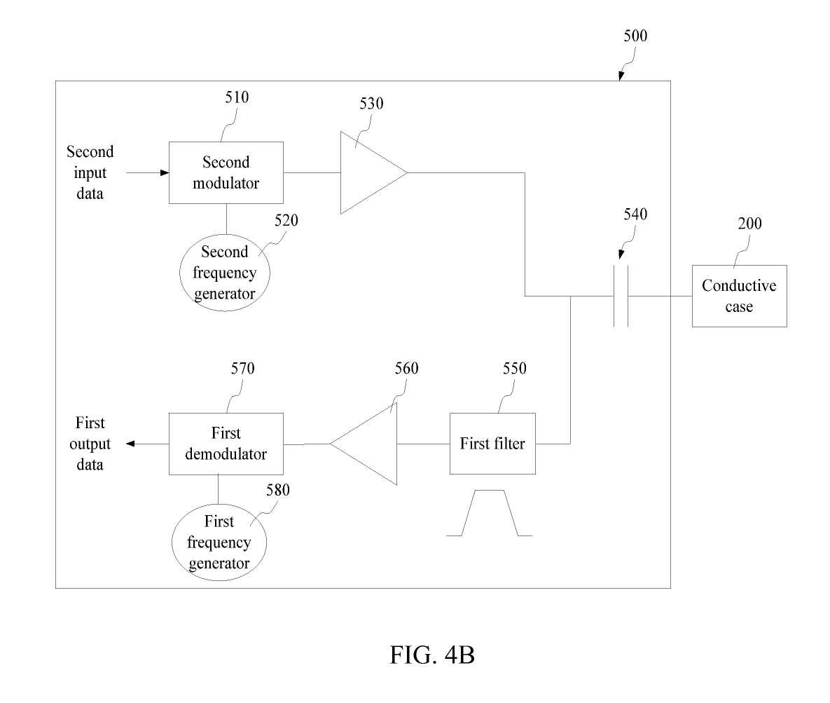

Please refer to FIG. 4A and FIG. 4B, which are the first embodiment of the signal transmission using the conductive case of the disclosure, each equipped on one end of the conductive case 200. FIG. 4A and FIG. 4B are the embodiment of the full-duplex example, which use two transceiver devices 400, 500. The full-duplex embodiment uses at least two operation frequencies while half-duplex example uses only one operation frequency and time division multiplexing (TDM). In another embodiment, when the first operation frequency and the second operation frequency are the same, the embodiment in FIG. 4A and FIG. 4B can be performed as half-duplex one.

The transceiver device 400, 500 are used for modulating/demodulating the corresponding input device with different operation frequency. That is, transceiver device 400 uses first operation frequency to modulate the first input data as the first modulated signal, and uses second operation frequency to demodulate the second modulated signal as the second output data. The transceiver device 500 does the contrary behavior to transceiver device 400, which uses second operation frequency to modulate the second input data as the second modulated signal, and uses first operation frequency to demodulate the first modulated signal as the first output data,

Please refer to FIG. 4A, the transceiver device 400 includes: first modulator 410, first frequency generator 420, amplifier 430, first capacitive unit 440, second filter 450, amplifier 460, second demodulator 470, and second frequency generator 480. In FIG. 4B, the transceiver device 500 includes: second modulator 510, second frequency generator 520, amplifier 530, second capacitive unit 540, first filter 550, amplifier 560, first demodulator 570, and first frequency generator 580.

The connection relationships between the parts of transceiver device 400, 500 are the same as FIG. 3. Therefore, the same connection and functional description will not be described in detail.

In transceiver device 400, the first input data is input to the first modulator 410. The first modulator 410 uses the first operation frequency generated by the first frequency generator 420 to modulate the first input data as the first modulated signal. The amplifier 430 amplifies the first modulated signal then the first capacitive unit 440 couples the first modulated signal to the conductive case 200.

In transceiver device 500, the second input data is input to the second modulator 510. The second modulator 510 uses the second operation frequency generated by the second frequency generator 520 to modulate the second input data as the second modulated signal. The amplifier 530 amplifies the second modulated signal then the second capacitive unit 540 couples the second modulated signal to the conductive case 200.

After the first and second modulated signals are generated, the conductive case 200 may carry two different modulated signals at the same time. When the first operation frequency and the second operation frequency are different and are designed as not interference with each other, the two modulated signal will be well transmitted through the conductive case 200. When the first operation frequency is the same as the second operation frequency, the TDM technology should be used to avoid the signal interference.

After the modulated signals are provided onto the conductive case 200, then the signal capturing and demodulating behavior should be made.

In transceiver 400, the second filter 450 can filter out the second operation frequency for the second modulated signal. The amplifier 460 then can amplify the second modulated signal. The second demodulator 470 then can use the second operation frequency generated by the second frequency generator 480 to demodulate the second modulated signal as the second output data.

In transceiver 500, the first filter 550 can filter out the first operation frequency for the first modulated signal. The amplifier 560 then can amplify the first modulated signal.

The first demodulator 570 then can use the first operation frequency generated by the first frequency generator 580 to demodulate the first modulated signal as the first output data.

In each transceiver device, another embodiment can adopt two capacitive units for transmitting part and receiving part.

While the disclosure has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A signal transmission method, operating on a conductive case, comprises the steps of:
coupling a plurality of capacitive interfaces to a plurality of ends of said conductive case;
modulating a transmission data as a modulated signal;
transmitting said modulated signal to one of the ends of said conductive case through said capacitive interface;
capturing said modulated signal from another one of the ends of said conductive case; and
demodulating said modulated signal as said transmission data for controlling a device coupled with said conductive case.

2. The signal transmission method according to claim 1, wherein said capacitive interface is capacitance or a coil.

3. A signal transmitting device, operating on a conductive case, said device comprising:
a frequency generation unit, for generating an operation frequency;
a modulation unit, coupling to said frequency generation unit, for receiving an input data and using said operation frequency to modulate said input data as a modulated signal; and
a capacitive coupling unit, coupling to said modulation unit and said conductive case, for transmitting said modulated signal to said conductive case.

4. The signal transmitting device according to claim 3, wherein said capacitive coupling unit is capacitance or a coil.

5. The signal transmitting device according to claim 3, further comprising,
an amplify unit, coupling between said modulation unit and said capacitive coupling unit, for amplifying said modulated signal.

6. A signal receiving device, operating on a conductive case, said device comprising:
a capacitive coupling unit, coupling to said conductive case, for capturing a modulated signal carried on said conductive case;
a frequency generation unit, for generating an operating frequency; and
a demodulation unit, coupling to said capacitive coupling unit and said frequency generation unit, for receiving said modulated signal and using said operation frequency to demodulate said modulated signal as an output data.

7. The signal receiving device according to claim 6, wherein said capacitive coupling unit is capacitance or a coil.

8. The signal receiving device according to claim 6, further comprising,
a filter unit, coupling to said capacitive coupling unit, for filtering a noise mixed in said modulated signal; and
an amplify unit, coupling between said modulation unit and said filter unit, for amplifying said modulated signal.

9. A signal transceiver device, operating on a conductive case, said device comprising:
a first frequency generation unit, for generating an first operation frequency;
a modulation unit, coupling to said frequency generation unit, for receiving an input data and using said first operation frequency to modulate said input data as a first modulated signal;
a first capacitive coupling unit, coupling to said modulation unit and said conductive case, for providing said first modulated signal to said conductive case and capturing a second modulated signal carried on said conductive case; and
a demodulation unit, coupling to said first capacitive coupling unit, for receiving said second modulated signal and demodulating said second modulated signal as an output data.

10. The signal transceiver device according to claim 9, wherein said capacitive coupling unit is capacitance or a coil.

11. The signal transceiver device according to claim 9, further comprising,
a first amplify unit, coupling between said modulation unit and said first capacitive coupling unit, for amplifying said first modulated signal.

12. The signal transceiver device according to claim 9, further comprising,
a filter unit, coupling to said first capacitive coupling unit, for filtering a noise mixed in said second modulated signal; and
a second amplify unit, coupling between said modulation unit and said filter unit, for amplifying said second modulated signal.

13. The signal transceiver device according to claim 9, further comprising,
a first amplify unit, coupling between said modulation unit and said first capacitive coupling unit, for amplifying said first modulated signal;
a filter unit, coupling to said first capacitive coupling unit, for filtering a noise mixed in said second modulated signal; and
a second amplify unit, coupling between said modulation unit and said filter unit, for amplifying said second modulated signal.

14. The signal transceiver device according to claim 9, further comprising,
a second frequency generation unit, coupling to said demodulation unit, for generating an second operating frequency for said demodulation unit to demodulate said second modulated signal.

15. The signal transceiver device according to claim 14, wherein said first frequency and said second frequency are the same frequency.

16. The signal transceiver device according to claim 14, wherein said first frequency and said second frequency are different frequencies.

17. The signal transceiver device according to claim 9, further comprising,
a second capacitive coupling unit, coupling to said demodulation unit, for capturing said second modulated signal.
